(19) United States
(12) Patent Application Publication
(10) Pub. No.: US 2013/0153774 A1
(43) Pub. Date: Jun. 20, 2013

(54) PIXELLATED SCINTILLATOR READOUT ARRANGEMENT AND METHOD

(71) Applicants: Patrick Joseph Hughes, Cork (IE); John Carlton Jackson, County Cork (IE); Nikolai Pavlov, County Cork (IE); Stephen Keeney, County Cork (IE)

(72) Inventors: Patrick Joseph Hughes, Cork (IE); John Carlton Jackson, County Cork (IE); Nikolai Pavlov, County Cork (IE); Stephen Keeney, County Cork (IE)

(73) Assignee: SENSL TECHNOLOGIES LTD., County Cork (IE)

(21) Appl. No.: 13/636,732

(22) PCT Filed: Mar. 23, 2011
(86) PCT No.: PCT/EP11/54490

§ 371 Date: Jan. 31, 2013

(30) Foreign Application Priority Data
Mar. 24, 2010 (GB) 1004923.7

(51) Int. Cl. G01T 1/20

(52) U.S. Cl. CPC G01T 1/2006
USPC 250/366

(57) ABSTRACT

A pixellated scintillator readout arrangement is presented, the arrangement comprising a plurality of scintillator pixels arranged in a scintillator array, and a plurality of photodetectors arranged to receive light from, or address, the scintillator pixels. The photodetectors may be arranged on both a first side and a second side of the scintillator array. Each photodetector may be arranged to leave a gap adjacent to the scintillator pixel which is addressed by that photodetector. Non-photosensitive elements such as tracking and bondpads may be arranged in at least some of the gaps. Electronic components such as electronic amplifiers may be arranged in at least some of the gaps. The photodetectors may be arranged in linear arrays addressing alternate lines of scintillator pixels on either side of the scintillator array. Each photodetector may be arranged to address a single pixel (as illustrated) or more than one pixel (not shown).

### TECHNICAL FIELD

The present invention relates to a pixellated scintillator readout arrangement and method.

### BACKGROUND

Silicon Photomultipliers (SPMs) are compact, high performance solid state detectors which are of growing importance for nuclear medicine and radiation detection systems. The disclosure presented herein uses SPM detectors and is of particular relevance to medical imaging scanners which use scintiliation radiation detection methods, such as Positron Emission Tomography (PET) including Time-of-Flight (TOF), gamma cameras and Positron Emission Mammography (PEM).

The photosensors used today in such applications range from vacuum based photomultiplier tubes (PMTs) and multichannel plates (MCPs) to solid-state arrays of avalanche photodiodes (APDs) or PIN photodiodes. The configuration of these systems is generally based on scintillation detection using crystal materials such as lutetium oxyorthosilicate (LSO) or LYSO (lutetium yttrium orthosilicate) or LaBr₃ (lanthanum (III) bromide) or BGO (bismuth germinate) or other. The scintillator materials are continuous or pixellated in manufacture and transfer the gamma ray or high-energy radiation collected into electromagnetic radiation whose spectral range matches the sensitivity of the photosensors.

The quality of clinical images in these systems is dependent on many parameters including spatial resolution, sensitivity, energy resolution and Depth of Interactions (DOI). The image quality is therefore dependent on the spatial localisation of the event both x, y and z directions. The uncertainty in localising an event in the z direction leads to reduced resolution due to parallax error in the line of response. This can be minimised by using appropriate Depth of Interaction (DOI) techniques which resolve the position of the event in the z direction. This is of particular importance when using thicker crystal sizes where parallax error is larger.

For PEM, a key limitation of present systems is the insufficient suppression of the background (chest cavity) which is external to the volume of material (breast) which is being imaged. By suppressing the background, the deterioration of the image is reduced and this improves the reliability of the diagnosis. In addition the radiation load to the patient can be reduced.

Better timing or resolution and countrate capability is therefore needed which can be achieved by using large-area, pixellated scintillator to photosensor readouts with 1:1 coupling between scintillator pixels and photosensor readouts to localise the detection event to one pixel location.

Solid state detectors can be used to improve the resolution of the image through 1:1 coupling to the crystal minimising or removing the need for a light guide which is typically placed between the crystal and the optical detector. However, large area pixellated detection hardware is challenging to manufacture as it requires the ratio of active photosensor area to total detector area (fill factor) to be maximised for optimal sensitivity. This requires minimal deadspace between pixels for electrical interconnections which is difficult to realise in large area formats.

### SUMMARY

An embodiment of the present invention aims to overcome the problems and disadvantages associated with current strategies and designs and to provide new methods for improving pixellated scintillator readout. In particular, an embodiment of the present invention addresses the integration of 2D pixellated SPM detector arrays with pixellated scintillators enabling Depth of Interaction (DOI) measurement estimates in a manner which minimises the constraints on photosensor packaging density and interconnects associated with prior art systems. The improvements in photosensor packaging and in the removal of constraints on the interconnects also reduces the requirements for the system to have DOI to improve image quality.

Another constraint on systems is the high cost of silicon required for a fully 1:1 coupled system. This could represent over 55 k channels for example in a human PET scanner. An embodiment of the present invention aims to overcome this constraint by minimising the number of detectors and channels in the system. This is of particular importance for TOF systems where extensive tracking out will degrade signal performance and increase the overall complexity of the design.

Pixellated scintillator arrays, in particular arrays providing DOI information have the potential to dramatically improve the performance of gamma cameras, in particular in PEM systems.

Detection and localisation of gamma events in the scintillator is performed by observation of the light flash induced by gamma quanta interaction in the scintillator. The advantage of pixellated scintillators is much more precise and reliable localisation of the gamma event interaction point in a given scintillator pixel via observation of the light flash in the corresponding photodiode channel, unlike the conventional Anger logic approach where the event is positioned via measurement of relative light output of several PMTs during the light flash.

There have been numerous efforts to provide a readout for a pixellated scintillator using either multichannel vacuum PMT or an array of semiconductor photodiodes of PIN or avalanche type, or a combination of both. Some of these prior art designs are intended to give out DOI information thus improving the gamma camera performance. However, there are many limitations associated with these detectors: vacuum PMTs are very bulky and expensive, PIN and avalanche photodiodes are expensive, and require short interconnects to special low noise electronic amplifiers. In addition, such photodiodes are plagued by the so called nuclear counter effect arising from direct detection of the gamma events in the photodiode rather than in the scintillator, allowing some wrong event data to appear, especially if using top (toward the gamma source) placement of the photodiode on the scintillator.

SPM devices were first developed in Russia in the mid 1980s. Referred to in the literature as SiPM, MRS APD or SSPM, the first actual photodetectors based upon this structure were produced in 1989. The SPM is an extension of the concept of the Geiger-Mode avalanche photodiode (GAPD) which is reported widely in the literature, see for example (a) Z. Y. Sadygov et al., “Avalanche Semiconductor Radiaton Detectors”, Trans. Nucl. Sci. Vol. 43, No. 3 (1996) 1009; and (b) V. Saveliev, “The Recent Development and Study of Silicon Photomultiplier”, Nucl. Instr. Meth. A 535 (2004) 528-532.

An SPM uses an array of photodiodes operating in Geiger mode with integrated quenching elements, summing the electrical output of all the diodes. The net result is a series of pulses (from the diodes that have detected a photon) being added together. As individual diodes detect photons the summed output will increase, or decrease as the output from the individual diodes is quenched. This produces an analogue electrical output which is proportional to the number of photons incident on the total sensor. The gain in this case is still>10⁵.

Compared with PMTs the technology is highly attractive in offering a low bias voltage, high gain, small form factor product which is not sensitive to magnetic fields or ambient light. SPMs are also known as SiPM [Silicon Photomultipliers], G-APD [Geiger Avalanche Photodiodes], MPPC [Micro Pixel Photon Counters] and have the potential to become a replacement for photomultiplier tubes (PMTs) and avalanche photodiodes (APDs) for use as photodetectors in positron emission topography (PET), Single photon emission computed tomography (SPECT), computed tomography (CT), and other radiation detectors. SPM devices are compact, have high gain, high quantum efficiency (about 20%-70%, which is better than that of traditional PMTs) and low noise. These devices have the potential to be used in time-of-flight PET applications due to their timing performance. Their insensitivity to magnetic fields is a quality which makes them ideal for use in an MR (magnetic resonance) environment.

SPMs produce a relatively large charge pulse when struck by a photon pulse of the same amplitude regardless of the energy of the photons (provided that the photons are of the spectral range to which the SPM is sensitive). When reading out conventional APDs, the noise of the preamplifier significantly degrades timing and amplitude resolution performance for short (shorter then approx 500 ns) light pulses. Compared to conventional APDs, SPMs provide much higher output amplitude, essentially eliminating the impact of preamplifier noise and allowing the use of much longer electrical interconnects between the photodiode and following amplifier electronics.

The SPMs are practically free from so-called “nuclear counter effect”, meaning they are insensitive to direct gamma interaction in the material of the SPM. Additionally they are can be fabricated on low resistivity, inexpensive silicon wafers using rather common silicon processing.

A solution which addresses both the performance requirements of PEM and hardware challenges for large area pixellated 1:1 coupling is desirable. By way of example, we present a compact construction method for the production of a detector to crystal to detector 3D stack to extract energy, timing and DOI of every event. The scintillation detection configuration proposed is formed using pixellated crystal sandwiched between two detection layers of matching pitch for the detector array.

Two coupling configurations of the detector array to the polished facets of the crystal at opposite sides are presented. To tile large area 2D SPM array requires new high fill factor packaging formats to butt couple SPM pixels on all four sides (four side buttable) with minimal non active, deadspace between pixels (<100 μm) and minimal electrical interconnection area or the ability to allow the electrical connection to the SPM to not interfere with other butt coupled SPM pixels in the array. Such methods have been realized.

The electrical interconnection from the die to the package has many variants including wirebond, flip-chip, tab bonds and surface mount. These are known techniques. The challenge for 2D SPM pixellated arrays is to minimize interconnect dead space needed for electrical connections from the pixel to the carrier. In the case of wirebonding this represents the wirebond area needed to process a wire loop from the bond pad of the pixel to a landing pad/finger located on the carrier. It is desirable to remove these constraints from the system and the following configurations highlight how this can be alleviated.

According to a first aspect of the invention, there is provided a pixellated scintillator readout arrangement comprising a plurality of scintillator pixels arranged in a scintillator array, and a plurality of photodetectors arranged to receive light from, or address, the scintillator pixels, wherein the photodetectors are positioned on both a first side and a second side of the scintillator array.

The photodetectors may comprise an avalanche photodiode or a Geiger mode avalanche photodiode. The photodetectors may comprise a silicon photomultiplier.

Each photodetector may be arranged to leave a gap adjacent to the scintillator pixel which is addressed by that photodetector. Non-photosensitive elements such as tracking and bondpads may be arranged in at least some of the gaps. Electronic components such as electronic amplifiers may be arranged in at least some of the gaps.

The photodetectors may be arranged in linear arrays addressing alternate lines of scintillator pixels on either side of the scintillator array. Each photodetector may be arranged to address a single pixel.

In an alternative arrangement, each photodetector may be arranged to address a first pixel and a second pixel. The first pixel may be substantially covered by the photodetector and the second pixel may be at least partially covered by the photodetector. Each pixel may be addressed from both the first side and second side of the array.

The photodetectors may be arranged in linear arrays with each linear array addressing first alternate lines of scintillator pixels on either side of the array, and each linear array may address second alternate lines of scintillator pixels adjacent to the first alternate lines, wherein each scintillator pixel may be addressed as part of a first line by a detector array on the first side of the array, and as part of a second line by a detector array on the second side of the array.

According to a second aspect of the invention there is provided a method of using a pixellated scintillator readout arrangement according to the first aspect of the invention in which the readout from both sides of the scintillator pixels is used to provide information on a depth of interaction.

### BRIEF DESCRIPTION OF THE DRAWINGS

FIGS. 1A and 1B show a scintillator readout without DOI capability (crossection in FIG. 1A and 3D view in FIG. 1B); and

FIGS. 2A and 2B show a scintillator readout with DOI capability (crossection view in FIG. 2A and 3D view in FIG. 2B).

### DETAILED DESCRIPTION

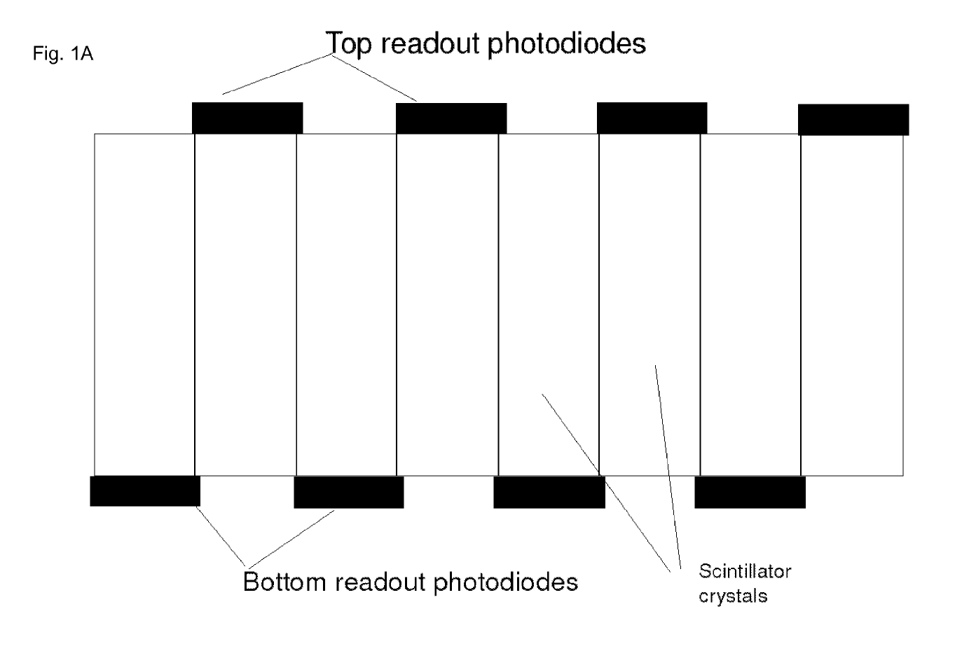

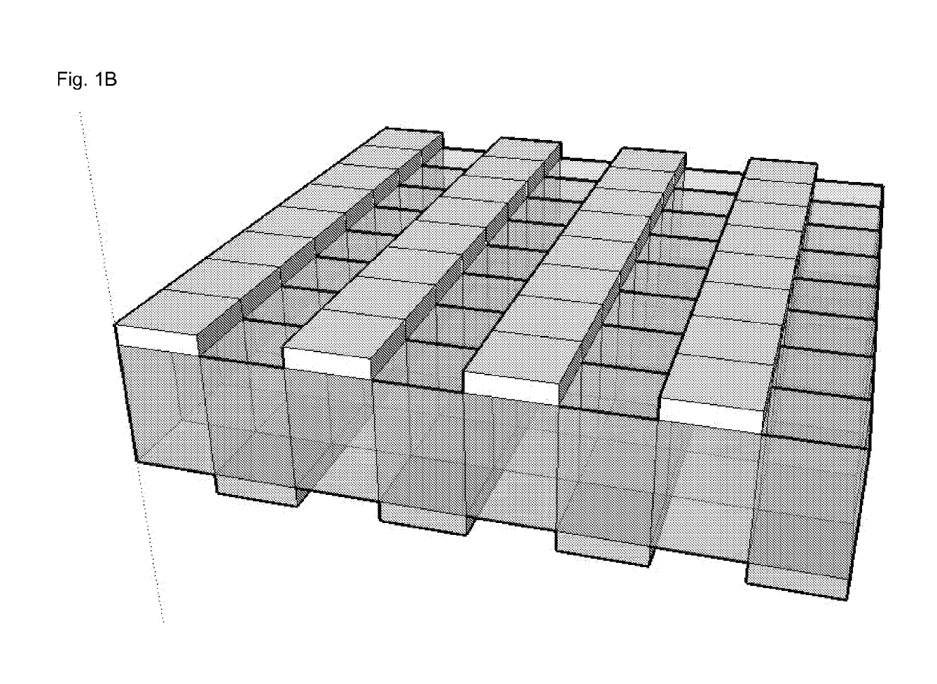

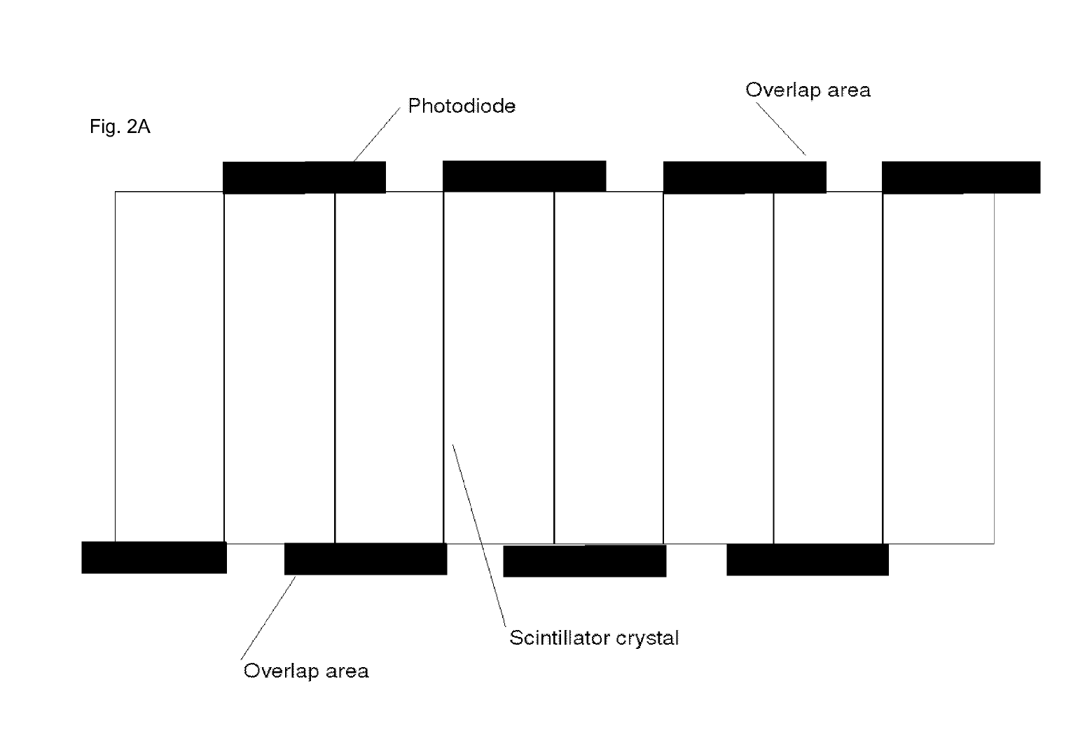

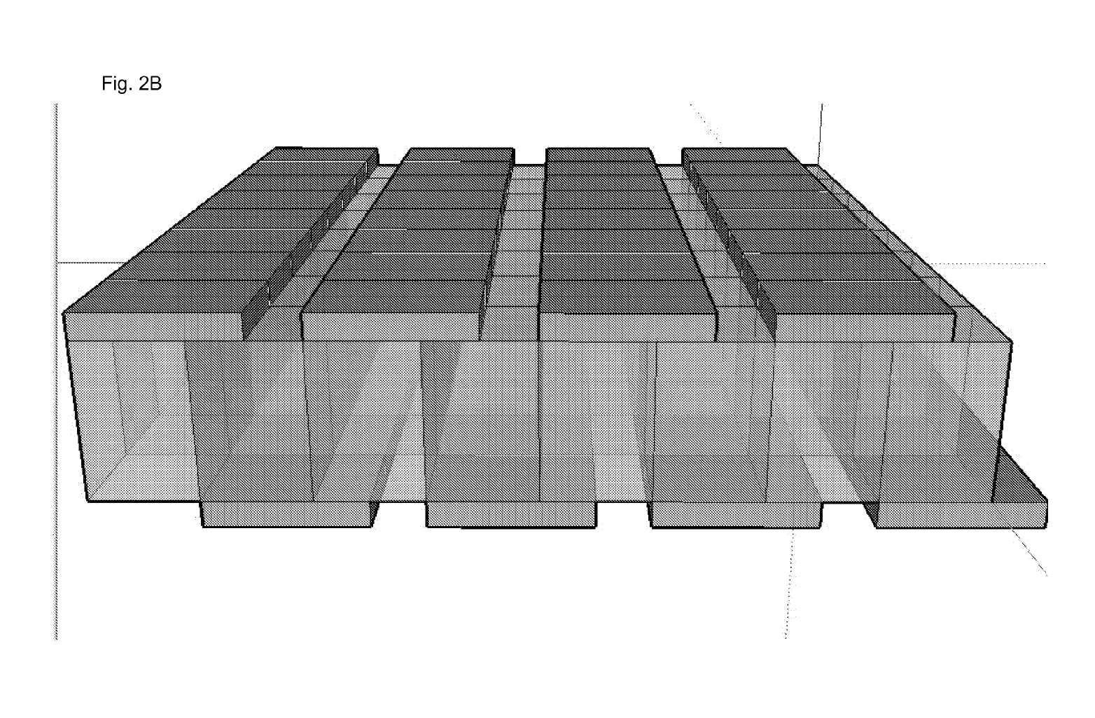

Two pixellated scintillator readout arrangements embodying the present invention will now be described with reference to FIGS. 1 and 2 respectively. Although presented as alternatives, they may both be used within the same device.

### 1) Alternating Side Readout (Non DOI Measurements)—see FIG. 1

In this first configuration, linear arrays of detectors are mounted on either side of the crystal end face. This configuration reduces the number of pixels required on each side of the crystal by staggering each linear array by a distance equivalent to the width of a pixel. The benefit of this packaging approach is that it removes rows of detector thus allowing metallisation tracks or lanes for routing signals.

This configuration enables a fully pixellated scintillator readout (1:1 coupling) for providing energy and timing information for every scintillation event in any scintillator crystal. This approach localises the position of the event which can determined spatially to within one pixel.

FIGS. 1A and 1B show such a scintillator readout without DOI capability (crossection in FIG. 1A and 3D view in FIG. 1B).

In this arrangement, the linear arrays of detectors may be a single pixel wide, and may extend in length across the scintillator pixel array. Each linear array of detectors is mounted to address a corresponding line of scintillator pixels. The linear arrays on each side of the scintillator pixel array are mounted to address alternate lines of scintillator pixels, with a linear detector array followed by a single pixel gap, followed by another single pixel wide linear array. The linear arrays on the second side of the scintillator array are offset by a single pixel width relative to those on the first side of the array so that each scintillator pixel in the array is addressed by a detector pixel. In this arrangement the active area of the detectors is not larger than the scintillator pixel and the detectors are not responsive to signals from adjacent scintillator pixels. The non-active area of each detector (not shown in FIGS. 1A and 1B) may be located offset from the scintillator pixel which it addresses, allowing the fill factor of each pixel to be maximised. The total area of each detector pixel including both active and non-active areas may therefore be larger than the scintillator pixel which it addresses, and the non-active area may extend into the gap between each alternate array of detectors. The non-active area of the detector pixel may comprise connecting tracks, bondpads and electronics, for example integrated electronic circuits and components.

### 2) Depth of Interaction (DOI) Scintillator Readout—see FIG. 2

In this second configuration detectors are again mounted in a linear array. However in this design the detection pixels cover one pixel scintillator and a partially neighbouring pixel. The enables DOI estimate by the observation of the ratio of signal in the top and bottom of the photosensors adjacent to the crystal of interaction. DOI is of particular importance when the thickness of the scintillator crystal is increased to achieve the necessary spatial resolution needed.

FIGS. 2A and 2B show such a scintillator readout with DOI capability (crossection view in FIG. 2A and 3D view in FIG. 2B).

In this arrangement, the linear arrays of detectors are arranged in a similar way to the first configuration, with linear arrays of detectors addressing alternate lines of scintillator pixels on either side of the array such that all the scintillator pixels are addressed. The active area which is sensitive to light of each detector pixel in the second configuration is larger than the scintillator pixel, and each detector in this arrangement addresses both a first pixel which is substantially covered by the detector, and a second pixel in the gap between the alternating linear arrays of detectors which is at least partially covered by the detector. In this way the detector pixel may have a first sensitivity to light from the first pixel and a second sensitivity to the second pixel. The first sensitivity may be higher than the second sensitivity. The second pixel partially addressed or covered by a pixel from a first side will be fully addressed by a pixel from the opposing side of the scintillator array.

As in the first configuration, the gaps between the active areas of the linear arrays may be used for non-active areas of the detectors (not shown in FIGS. 2A and 2B). The non-active area of the detector pixel may comprise connecting tracks, bondpads and electronics, for example integrated electronic circuits and components.

In summary, we have presented a method of SPM-based pixellated scintillator readout using alternating top and bottom placed readout photodiode elements grouped as linear arrays, thus allowing spacing out any of neighbouring elements on both sides. Both the first and second configurations allow connecting tracks, bondpads and electronics to be located adjacent to the active detector region without compromising the fill factor and therefore performance of the detectors.

Some overlap of the photodiode to the neighbouring scintillator crystal may be intentionally introduced thus allowing for light sharing of the scintillator light between two opposing photodiodes and consequently enabling Depth-Of-Interaction estimate.

The interconnecting tracking may be performed in such a way that uniform track lengths are used to minimise non-uniformity and signal degradation and maximise TOF performance. The extra space could be further utilised to include additional chip amplifiers to improve performance.

It will be appreciated by the person of skill in the art that various modifications may be made to the above described embodiments without departing from the scope of the present invention.

1. A pixellated scintillator readout arrangement comprising a plurality of scintillator pixels arranged in a scintillator array, and a plurality of photodetectors arranged to receive light from, or address, the scintillator pixels, wherein the photodetectors are arranged on both a first side and a second side of the scintillator array.

2. An arrangement as claimed in claim 1, wherein the photodetectors comprise an avalanche photodiode or a Geiger mode avalanche photodiode.

3. An arrangement as claimed claim 1, wherein each photodetector comprises a silicon photomultiplier.

4. An arrangement as claimed in claim 1, wherein each photodetector is arranged to leave a gap adjacent to the scintillator pixel which is addressed by that photodetector.

5. An arrangement as claimed in claim 4, wherein non-photosensitive elements such as tracking and bondpads are arranged in at least some of the gaps.

6. An arrangement as claimed in claim 4, wherein electronic components such as electronic amplifiers are arranged in at least some of the gaps.

7. An arrangement as claimed in claim 1, wherein the photodetectors are arranged in linear arrays addressing alternate lines of scintillator pixels on either side of the scintillator array.

8. An arrangement as claimed in claim 1, wherein each of at least some of the photodetectors is arranged to address a single pixel.

9. An arrangement as claimed in claim 1, wherein each of at least some of the photodetectors is arranged to address a first pixel and a second pixel.

10. An arrangement as claimed in claim 9, wherein the first pixel is substantially covered by the photodetector and the second pixel is at least partially covered by the photodetector.

11. An arrangement as claimed in claim 9, wherein each pixel is addressed from both the first side and second side of the array.

12. An arrangement as claimed in claim 11, wherein the photodetectors are arranged in linear arrays with each linear array addressing first alternate lines of scintillator pixels on either side of the array, and with each linear array addressing second alternate lines of scintillator pixels adjacent to the first alternate lines, wherein each scintillator pixel is addressed as part of a first line by a detector array on the first side of the array, and as part of a second line by a detector array on the second side of the array.

13. A method of using a pixellated scintillator readout arrangement according to claim 11, in which the readout from both sides of the scintillator pixels is used to provide information on a depth of interaction.

14. A silicon photomultiplier based pixellated scintillator readout arrangement having alternating top and bottom placed readout photodiode elements grouped as linear arrays, thereby allowing spacing out any of neighbouring elements on both sides.

15. An arrangement as claimed in claim 14, having some overlap of a photodiode to the neighbouring scintillator crystal thus allowing for light sharing of the scintillator light between two opposing photodiodes and consequently enabling a depth-of-interaction estimate.

16. An arrangement as claimed in claim 14, having tracking with uniform track lengths to minimise non-uniformity and signal degradation and maximise TOF.

17. An arrangement as claimed in claim 14, in which the extra space is used to include additional chip amplifiers so as to improve performance.
